(19) United States
(12) Patent Application Publication
(10) Pub. No.: US 2002/0109658 A1
(43) Pub. Date: Aug. 15, 2002

(54) Display device

(75) Inventor: Yukihiro Noguchi, Motosu-gun (JP)

Correspondence Address: McDERMOTT, WILL & EMERY, 600 13th Street, N.W., Washington, DC, 20005-3096, US

(73) Assignee: Sanyo Electric Co., Ltd.

(21) Appl. No.: 10/062,660

(22) Filed: Feb. 5, 2002

(30) Foreign Application Priority Data
Feb. 15, 2001 (JP) JP2001-37805

(51) Int. Cl. G09G 3/36

(52) U.S. Cl. 345/92

(57) ABSTRACT

A display device capable of preparing a display device having a larger size and capable of enabling a miniature display device (display panel) to collectively arrange a signal line driving circuit and a scanning line driving circuit on the same side is obtained. In this display device, the signal line driving circuit and the scanning line driving circuit are arranged on the same peripheral side of a display area in a cascaded manner. Thus, other display devices (display panels) can be bonded to the three remaining sides of the display area. Therefore, the number of display devices (display panels) bonded to each other in a row direction is so unlimited that a display device having a larger size can be prepared. As compared with a case of transversely arranging the signal line driving circuit and the scanning line driving circuit on the same side, the width for arranging the signal line driving circuit and the scanning line driving circuit is reduced. Thus, the signal line driving circuit and the scanning line driving circuit can be collectively arranged on the same side also in a miniature display device (display panel).

### BACKGROUND OF THE INVENTION

1. Field of the Invention

The present invention relates to a display device, and more specifically, it relates to a display device including a pixel electrode.

2. Description of the Prior Art

Display devices including pixel electrodes are known in recent years. The display devices are roughly classified into a passive matrix display device and an active matrix display device. In the active matrix display device, a switching element is provided for each pixel, for applying a voltage (or feeding a current) responsive to image data to each pixel and making display.

In a liquid crystal display (LCD) filled up with liquid crystals between opposite substrates, a voltage is applied to a pixel electrode formed every pixel for varying the permeability of the liquid crystals thereby displaying an image. The active matrix LCD having high display definition forms the mainstream particularly in application to a monitor.

In an electroluminescence (EL) display, a pixel electrode formed every pixel feeds a current to an EL element thereby displaying an image. Active study is recently made on the active matrix EL display, in order to put the same into practice.

Particularly when a semiconductor layer of a thin-film transistor (TFT) applied to a switching element is fabricated as the so-called low-temperature polysilicon TFT without through a high-temperature process, various peripheral circuits can be integrally formed on a glass substrate. Therefore, no driving IC may be connected to the periphery but the cost can be reduced. The low-temperature polysilicon TFT is applicable to various active matrix display devices such as a plasma display and a field emission display (FED), in addition to the aforementioned LCD and EL display.

FIG. 7 is a conceptual diagram showing a conventional active matrix LCD. Referring to FIG. 7, an external control circuit 200 is connected to an LCD panel 150 formed by arranging various circuits on a glass substrate. In order to operate the LCD panel 150, the external control circuit 200 supplies various control signals, video signals and a power supply voltage V_{DD} to the LCD panel 150.

A display area 10 and various circuits are arranged on the LCD panel 150. A plurality of pixel electrodes (not shown) arranged in the form of a matrix, a plurality of signal lines 23 extending in a column direction and a plurality of scanning lines 24 extending in a row direction are arranged on the display area 10. Selection transistors (not shown) are arranged on the intersections between the signal lines 23 and the scanning lines 24 respectively. The selection transistors have drains or sources connected to the signal lines 23 and gates connected to the scanning lines 24. The sources or the drains of the selection transistors are connected to the pixel electrodes. A color filter of any of the primary colors red, green and blue is arranged in correspondence to each pixel electrode. Thus, the active matrix LCD makes color display. A signal line driving circuit 21 is arranged on the column side of the display area 10 while a scanning line driving circuit 22 is arranged on the row side thereof.

FIG. 8 is a circuit diagram showing the internal structure of the signal line driving circuit 21 of the conventional active matrix LCD shown in FIG. 7. Referring to FIG. 8, the conventional signal line driving circuit 21 has a plurality of shift registers 25 (25a, 25b, 25c, 25d, . . . ), a plurality of buffers 26 (26a, 26b, 26c, 26d, . . . ) and a plurality of analog switches 27 (27a, 27b, 27c, 27d, . . . ). A control signal (horizontal clock signal) CKH supplied from the external control circuit 200 is input in the shift registers 25 (25a, 25b, 25c, 25d, . . . ).

Inputs of the buffers 26 (26a, 26b, 26c, 26d, . . . ) are connected with outputs of the shift registers 25 (25a, 25b, 25c, 25d, . . . ) respectively, while outputs of the buffers 26 (26a, 26b, 26c, 26d, . . . ) are connected with inputs of the analog switches 27 (27a, 27b, 27c, 27d, . . . ) respectively. Video signal lines 30R, 30G and 30B of red, green and blue are connected to the analog switches 27 (27a, 27b, 27c, 27d, . . . ). The shift registers 25 (25a, 25b, 25c, 25d, . . . ) are connected with the adjacent shift registers 25 (25a, 25b, 25c, 25d, . . . ) respectively, to be continuously arranged.

Operations of the conventional active matrix LCD are now described. The scanning line driving circuit 22 successively selects a prescribed scanning line 24 from the plurality of scanning lines 24 and applies a gate voltage V_{G} thereto. Thus, the selection transistor connected to the scanning line 24 receiving the gate voltage V_{G} is turned on. The scanning line driving circuit 22 selects the first scanning line 24 in response to a start signal VST, and successively switches to and selects the next scanning line 24 in response to a vertical clock CKV.

The signal line driving circuit 21 selects a prescribed signal line 23 from the plurality of signal lines 23. The signal line driving circuit 21 supplies video signals of red, blue and green to the pixel electrodes through the signal line 23 and the selection transistor. In this case, the signal line driving circuit 21 selects one or a plurality of signal lines 23 at once. The signal line driving circuit 21 selects the first signal line 23 in response to a horizontal start signal HST, and successively switches to and selects the next signal line 23 in response to a horizontal clock CKH.

More specifically, the horizontal start signal HST is first input in the first-stage shift register 25a. When receiving the horizontal start signal HST, the output of the shift register 25a goes high for a period of one cycle of the horizontal clock CKH. The output of the shift register 25a turns on the analog switch 27a, and the video signal lines 30R, 30G and 30B supply video signals to signal lines 23Ra, 23Ga and 23Ba respectively. Then, the output of the shift register 25a is input in the second-stage shift register 25b. The output of the shift register 25b goes high for a next period of one cycle of the horizontal clock CKH, and the video signals of the video signal lines 30R, 30G and 30B are supplied to signal lines 23Rb, 23Gb and 23Bb respectively. Similarly, the remaining shift registers 25 successively go high to successively select the signal lines 23 and supplying the video signals to all pixels.

When all signal lines 23 for one row are selected, the vertical clock CKV shifts to a next cycle and the scanning line driving circuit 22 supplies the gate voltage V_{G} to a next scanning line 24. The horizontal start signal HST is input again so that the output of the first-stage shift register 25a goes high.

In the aforementioned active matrix display device formed by integrally forming various peripheral circuits on the glass substrate with the low-temperature polysilicon TFTs, however, fabrication steps are so complicated that it is extremely difficult to prepare a large-sized display device while the yield is inferior.

Japanese Utility Model Laying-Open No. 60-191029 (1985) or the like proposes a method of preparing a large-sized display device by bonding a plurality of miniature display devices (display panels) to each other. FIG. 9 illustrates an exemplary active matrix LCD formed by bonding four miniature display devices to each other. In the prior art shown in FIG. 9, however, signal line driving circuits 21 are arranged on column sides of display areas 10 while scanning line driving circuits 22 are arranged on row sides thereof, and hence only four miniature display devices can be bonded to each other at the maximum. Thus, it is difficult to prepare a display device having a larger size.

### SUMMARY OF THE INVENTION

An object of the present invention is to provide a display device capable of preparing a display device having a larger size by bonding at least four display devices (display panels) to each other.

Another object of the present invention is to enable a miniature display device (display panel) to collectively arrange a signal line driving circuit and a scanning line driving circuit on the same side in the aforementioned display device.

Still another object of the present invention is to effectively prevent the aforementioned display device from deterioration of image display resulting from delay or the like.

A display device according to an aspect of the present invention comprises a display area, a plurality of scanning lines arranged in a first direction, a plurality of signal lines arranged in a second direction, a signal line driving circuit successively selecting a prescribed signal line from the plurality of signal lines and supplying a video signal and a scanning line driving circuit successively selecting a prescribed scanning line from the plurality of scanning lines and supplying a scanning signal, while the signal line driving circuit and the scanning line driving circuit are arranged on the same peripheral side of the display area in a cascaded manner.

In the display device according to this aspect, the signal line driving circuit and the scanning line driving circuit are arranged on the same peripheral side of the display area as described above, whereby other display devices (display panels) can be bonded to the three remaining peripheral sides of the display area. Thus, the number of other display devices (display panels) bonded to each other in the row direction is so unlimited that a display device of a larger size can be prepared. When the signal line driving circuit and the scanning line driving circuit are arranged on the same side in a cascaded manner, the width for arranging the signal line driving circuit and the scanning line driving circuit can be reduced as compared with a case of transversely arranging the signal line driving circuit and the scanning line driving circuit on the same side. Thus, the signal line driving circuit and the scanning line driving circuit can be collectively arranged on the same side also in a display device (display panel) so miniature that it is difficult to arrange the signal line driving circuit and the scanning line driving circuit on the same side.

In the display device according to the aforementioned aspect, the scanning line driving circuit is preferably arranged outward beyond the signal line driving circuit. According to this structure, the signal line driving circuit is arranged on the inner side closer to the display area, whereby the distance between the signal line driving circuit and the display area can be set equivalent to that in the prior art. Thus, it is possible to effectively prevent deterioration of image display resulting from delay of a video signal or the like.

In this case, the signal line driving circuit preferably includes a plurality of shift registers, a plurality of buffers and a plurality of analog switches, and the shift registers, the buffers and the analog switches for adjacent signal lines are preferably arranged in a cascaded manner respectively. According to this structure, the distance between driving circuits for the respective signal lines can be increased without changing the width of the signal line driving circuit. Thus, a wire from the scanning line driving circuit can be passed through adjacent signal line driving circuits. Consequently, neither insulating layer nor wiring layer may be newly formed for wiring the scanning lines, and hence the number of steps of the fabrication process is not increased. In this case, the display device may further comprise a video signal line connected to the analog switches, and the video signal line may include a first video signal line connected to the analog switches of odd stages and a second video signal line connected to the analog switches of even stages.

In the aforementioned case, a wire from the scanning line driving circuit is preferably input in the display area through the shift registers, the buffers and the analog switches arranged in a cascaded manner and shift registers, buffers and analog switches arranged adjacently thereto in a cascaded manner. According to this structure, the wire from the scanning line driving circuit can be readily passed through the respective signal line driving circuits. In this case, the wire from the scanning line driving circuit is preferably connected to the scanning lines arranged in the row direction in the display area column-directionally through the shift registers, the buffers and the analog switches arranged in a cascaded manner and the shift registers, the buffers and the analog switches arranged adjacently thereto in a cascaded manner. According to this structure, the traveling direction of a scanning signal input in the display area can be converted from the column direction to the row direction.

In the display device according to the aforementioned aspect, the display area, the signal line driving circuit and the scanning line driving circuit are preferably formed on a display panel. According to this structure, the number of external connecting terminals can be reduced as compared with a case of providing the signal line driving circuit and the scanning line driving circuit outside the display panel.

The display device according to the aforementioned aspect preferably further comprises a plurality of display panels each including the display area, the scanning lines, the signal lines, the signal line driving circuit and the scanning line driving circuit, the signal line driving circuit and the scanning line driving circuit in each of the plurality of display panels are preferably arranged on the same peripheral side of the display area in a cascaded manner, and the plurality of display panels are preferably connected with each other at least on a side of each display panel other than the side provided with the signal line driving circuit and the scanning line driving circuit. According to this structure, the number of display panels bonded to each other in the row direction is so unlimited that a large-sized display device can be readily prepared. When the signal line driving circuit and the scanning line driving circuit are arranged on the same side in a cascaded manner, the width for arranging the signal line driving circuit and the scanning line driving circuit can be reduced as compared with a case of transversely arranging the signal line driving circuit and the scanning line driving circuit on the same side. Thus, the signal line driving circuit and the scanning line driving circuit can be collectively arranged on the same side also in a display device (display panel) so miniature that it is difficult to arrange the signal line driving circuit and the scanning line driving circuit on the same side.

In this case, the plurality of display panels may be connected with each other at least on two sides or three sides of each display panel other than the side provided with the signal line driving circuit and the scanning line driving circuit. Further, the display panels may be connected with each other in an even number of at least six.

In the display device according to the aforementioned aspect, the display area may include a plurality of pixels arranged in the form of a matrix. Further, the display device may include a liquid crystal display.

The display device according to the aforementioned aspect may include an EL (electroluminescence) display. In this case, a current supply line is preferably arranged on the display area of the EL display. The display area of the EL display preferably includes a plurality of pixels arranged in the form of a matrix, and each pixel preferably includes a switching transistor, a capacitor, an EL element and a driving transistor. According to this structure, display can be readily made with the EL element.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a conceptual diagram of an active matrix LCD according to a first embodiment of the present invention;

FIG. 2 is a circuit diagram showing the internal structure of a signal line driving circuit of the active matrix LCD according to the first embodiment shown in FIG. 1;

FIG. 3 is a front elevational view showing an active matrix LCD formed by bonding LCD panels according to the first embodiment shown in FIGS. 1 and 2 to each other;

FIG. 4 is a conceptual diagram of an active matrix EL display according to a second embodiment of the present invention;

FIG. 5 is a circuit diagram showing the structure of a pixel forming a display area of the active matrix EL display according to the second embodiment shown in FIG. 4;

FIG. 6 is a front elevational view showing an active matrix EL display formed by bonding EL panels according to the second embodiment shown in FIG. 4 to each other;

FIG. 7 is a conceptual diagram of a conventional active matrix LCD;

FIG. 8 is a circuit diagram showing the internal structure of a signal line driving circuit of the conventional active matrix LCD shown in FIG. 7; and

FIG. 9 is a front elevational view showing an active matrix LCD formed by bonding conventional LCD panels shown in FIGS. 7 and 8 to each other.

### DESCRIPTION OF THE PREFERRED EMBODIMENTS

Embodiments of the present invention are now described with reference to the drawings.

(First Embodiment)

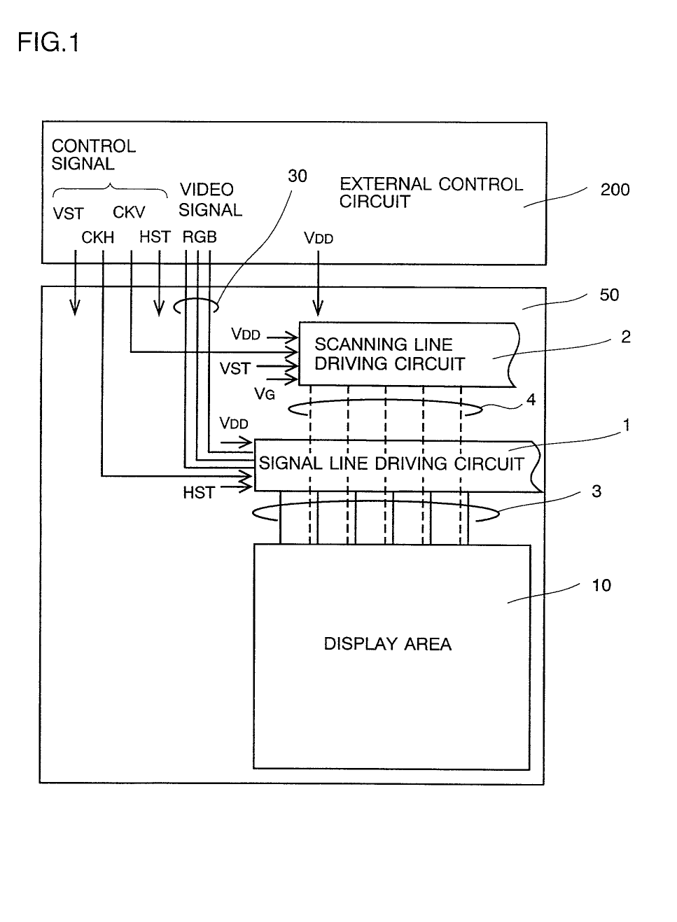

Referring to FIG. 1, an external control circuit 200 is connected to an LCD panel 50 having various circuits arranged on a glass substrate in an active matrix LCD according to a first embodiment of the present invention. The LCD panel 50 is an example of the “display panel” according to the present invention. In order to operate the LCD panel 50, the external control circuit 200 supplies various control signals, video signals, a power supply voltage V_{DD} and the like to the LCD panel 50.

A display area 10 and various circuits are arranged on the LCD panel 50. A plurality of pixel electrodes (not shown) arranged in the form of a matrix, a plurality of signal lines 3 extending in a column direction and a plurality of scanning lines 4 extending in a row direction are arranged on the display area 10. Selection transistors (not shown) are arranged on the intersections between the signal lines 3 and the scanning lines 4 respectively. The selection transistors have drains or sources connected to the signal lines 3 and gates connected to the scanning lines 4. The selection transistors also have sources or drains connected to the pixel electrodes. A color filter of any of the primary colors red, green and blue is arranged in correspondence to each pixel electrode. Thus, the active matrix LCD makes color display.

According to the first embodiment, a signal line driving circuit 1 and a scanning line driving circuit 2 are arranged on the same side of the display area 10 in a cascaded manner. The scanning line driving circuit 2 is arranged outward beyond the signal line driving circuit 1. Video signals from the signal line driving circuit 1 are input in the display area 10 through the signal lines 3, while scanning signals from the scanning line driving circuit 2 are input in the display area 10 through the scanning lines 4. The scanning lines 4 are connected with prescribed scanning lines 4 extending in the row direction in the display area 10. Therefore, the traveling direction of the scanning signals input in the display area 10 is converted from the column direction to the row direction, and thereafter the scanning signals are input in the gates of the selection transistors.

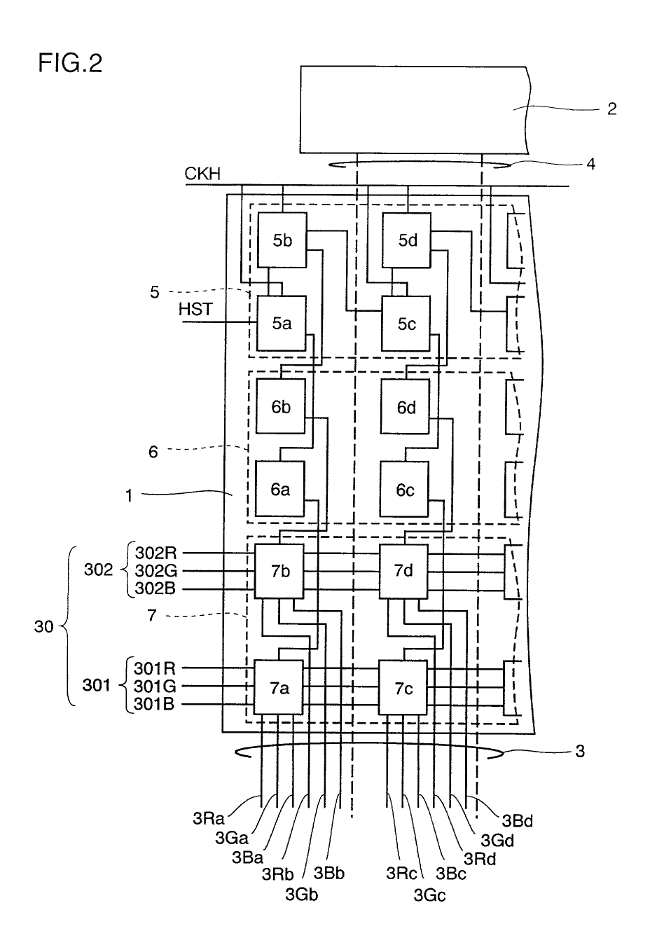

The internal structure of the signal line driving circuit 1 according to the first embodiment is now described in detail with reference to FIG. 2. The signal line driving circuit 1 has a plurality of shift registers 5 (5a, 5b, 5c, 5d, . . . ), a plurality of buffers 6 (6a, 6b, 6c, 6d, . . . ) and a plurality of analog switches 7 (7a, 7b, 7c, 7d, . . . ).

According to the first embodiment, the first- and second-stage shift registers 5a and 5b are arranged in a cascaded manner. The first- and second-stage buffers 6a and 6b are also arranged in a cascaded manner. Further, the first- and second-stage analog switches 7a and 7b are also arranged in a cascaded manner. In addition, the third- and fourth-stage shift registers 5c and 5d, the third- and fourth-stage buffers 6c and 6d and the third- and fourth-stage analog switches 7c and 7d are also arranged in a cascaded manner. The fifth- and sixth-stage shift elements, the seventh- and eighth-stage elements and subsequent elements also have similar structures.

According to the first embodiment, the first- and second-stage elements as well as the third- and fourth-stage elements are thus arranged in a cascaded manner respectively, whereby the second- and third-stage elements are separated from each other by a space corresponding to the second-stage circuit and provided with only a wire. The scanning lines 4 from the scanning line driving circuit 2 are input in the display area 10 through such spaces.

A control signal (horizontal clock signal) CKH supplied from the external control circuit 200 is input in the shift registers 5 (5a, 5b, 5c, 5d, . . . ). Outputs of the shift registers 5 (5a, 5b, 5c, 5d, . . . ) are connected with inputs of the buffers 6 (6a, 6b, 6c, 6d, . . . ) respectively, while outputs of the buffers 6 (6a, 6b, 6c, 6d, . . . ) are connected with inputs of the analog switches 7 (7a, 7b, 7c, 7d, . . . ) respectively. A video signal line 30 of red, green and blue is connected to the analog switches 7 (7a, 7b, 7c, 7d, . . . ), and an output thereof is connected to the signal lines 3.

The external control circuit 200 inputs the video signal line 30, which is divided into video signal lines 301 and 302 connected to the odd- and even-stage analog switches 7. Video signals on the video signal lines 301 and 302 may be identical to each other, or may be modulated for the odd and even stages.

The first-stage shift register 5a is connected with the second-stage shift register 5b, which in turn is connected with the third-stage shift register 5c, which in turn is connected with the fourth-stage shift register 5d. The subsequent shift registers 5 are also continuously connected with each other.

Operations of the active matrix LCD according to the first embodiment are now described. First, basic operations of the signal line driving circuit 1 and the scanning line driving circuit 2 are similar to those of the prior art. The scanning line driving circuit 2 selects the first scanning line 4 in response to a vertical start signal VST, successively switches to the next scanning line 4 in response to a vertical clock CKV and applies a gate voltage V_{G}. The signal line driving circuit 1 selects the first signal line 3 in response to a horizontal start signal HST, successively switches to the next signal line in response to a horizontal clock CKH and supplies the video signals.

More specifically, the horizontal start signal HST is first input in the first-stage shift register 5a. When receiving the horizontal start signal HST, the output of the shift register 5a goes high for a period of one cycle of the horizontal clock CKH. The output of the shift register 5a turns on the analog switch 7a, and video signal lines 301R, 301G and 301B supply video signals to signal lines 3Ra, 3Ga and 3Ba respectively. The output of the shift register 5a is also input in the second-stage shift register 5b, the output of which goes high for a next period of one cycle of the horizontal clock CKH. Thus, the video signals of video signal lines 302R, 302G and 303B are supplied to signal lines 3Rb, 3Gb and 3Bb respectively. Thereafter the shift registers 5 successively go high in a similar manner, thereby successively selecting the signal lines 3 and supplying the video signals to all pixels.

When all signal lines 3 for one row are selected, the vertical clock CKV shifts to a next cycle and the scanning line driving circuit 2 supplies the gate voltage V_{G} to the next scanning line 4. The horizontal start signal HST is input again and the output of the first-stage shift register 5a goes high.

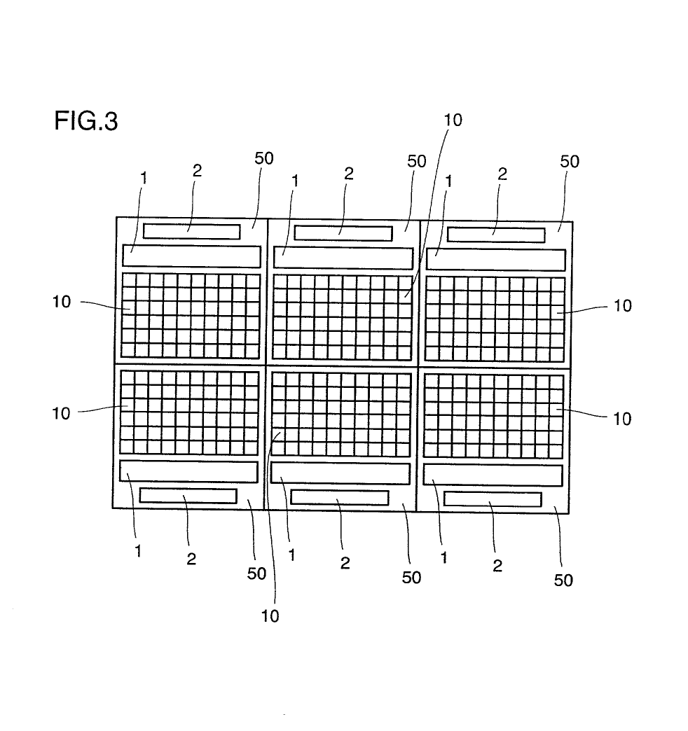

According to the aforementioned first embodiment, the signal line driving circuit 1 and the scanning line driving circuit 2 are arranged on the same side of the display area 10 so that no driving circuits are arranged on the remaining three sides other than that provided with the signal line driving circuit 1 and the scanning line driving circuit 2, whereby other LCD panels 50 can be connected to these three sides respectively. Thus, a large-sized LCD panel can be prepared by bonding miniature LCD panels 50 to each other, as shown in FIG. 3. While six LCD panels 50 are bonded to each other in FIG. 3, the number of the LCD panels 50 bonded to each other in the row direction is so unlimited that the LCD panels 50 can be bonded to each other to reach a desired size in the structure according to the first embodiment.

According to the first embodiment, the signal line driving circuit 1 and the scanning line driving circuit 2 are arranged on the same side in a cascaded manner, whereby the width for arranging the signal line driving circuit 1 and the scanning line driving circuit 2 can be reduced as compared with a case of transversely arranging the signal line driving circuit 1 and the scanning line driving circuit 2 on the same side. Thus, also in the miniature LCD panel 50 having difficulty in arranging the signal line driving circuit 1 and the scanning line driving circuit 2 on the same side, the signal line driving circuit 1 and the scanning line driving circuit 2 can be collectively arranged on the same side.

According to the first embodiment, the scanning line driving circuit 2 is arranged outward beyond the signal line driving circuit 1 so that the signal line driving circuit 1 is arranged on the inner side closer to the display area 10, whereby the distance between the signal line driving circuit 1 and the display area 10 can be set equivalent to that in the prior art. Thus, it is possible to effectively prevent deterioration of image display resulting from delay of the video signals or the like.

According to the first embodiment, further, pairs of the shift registers 5, the buffers 6 and the analog switches 7 such as the first- and second-stage elements and the third- and fourth-stage elements are arranged in a cascaded manner respectively as described above, whereby a space corresponding to one stage is defined between the second- and third-stage elements, for example. Thus, the scanning lines 4 output from the scanning line driving circuit 1 can pass through such spaces. Also when the signal line driving circuit 1 and the scanning line driving circuit 2 are arranged in a cascaded manner, therefore, the scanning lines 4 may not be arranged on active layers of transistors forming the signal line driving circuit 1, whereby neither insulating layers nor wiring layers may be newly provided for wiring the scanning lines 4.

(Second Embodiment)

According to a second embodiment of the present invention, the inventive display device is applied to an active matrix EL display.

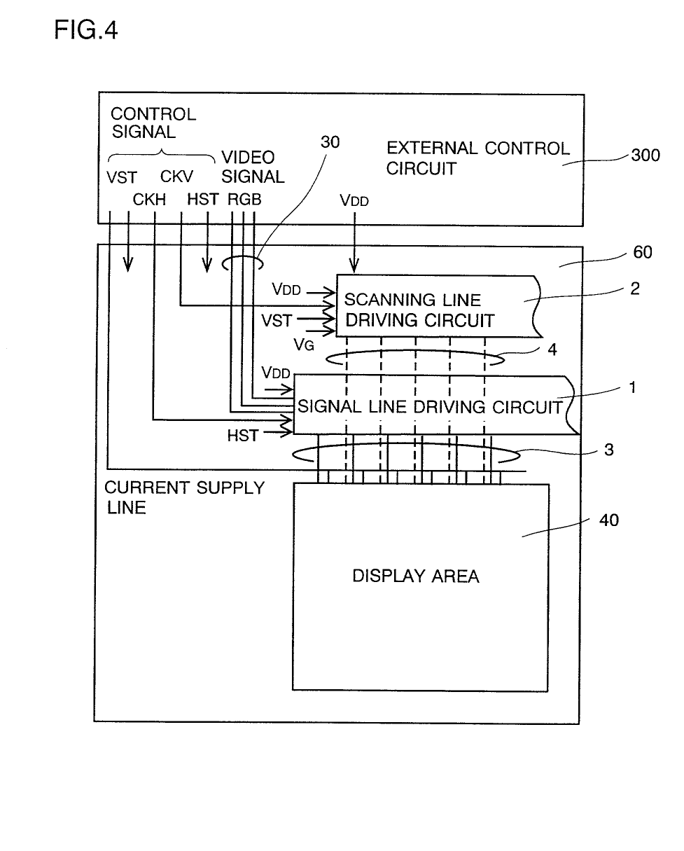

Referring to FIG. 4, the active matrix EL display according to the second embodiment is different from the active matrix LCD shown in FIG. 1 in a point that current supply lines are arranged on a display area 40 of an EL panel 60 from an external control circuit 300. The EL panel 60 is an example of the “display panel” according to the present invention. Further, a driving circuit for each pixel forming the display area 40 and a display element are also different from those in the first embodiment.

More specifically, the circuit for each pixel forming the display area 40 according to the second embodiment includes a switching transistor 41, a capacitor 42, an EL element 43 and a driving transistor 44, as shown in FIG. 5. The switching transistor 41 has a gate connected to a scanning line 4 (Scan1) and a drain or a source connected to a signal line 3 (Data1). The switching transistor 41 is turned on/off by a scanning signal Scan1. A voltage Vh1 responsive to the amplitude of a video signal Data1 supplied through the signal line 3 when the switching transistor 41 is on is charged to the capacitor 42, which holds the charging voltage Vh1 when the switching transistor 41 is off.

The drain or the source of the driving transistor 44 is connected to a current supply line (driving power supply voltage COM), and the source or the drain of the driving transistor 44 is connected to a cathode or an anode of the EL element 43. A first terminal of the capacitor 42 is connected to the gate of the driving transistor 44. Thus, the capacitor 42 supplies the holding voltage Vh1 to the driving transistor 44, thereby driving the EL element 43.

In operation, the scanning signal Scan1 goes high to turn on the switching transistor 41, whereby the video signal Data1 is supplied to an end of the capacitor 42. Thus, the capacitor 42 is charged with the voltage Vh1 responsive to the amplitude of the video signal Data1. The capacitor 42 continuously holds the voltage Vh1 for a vertical scanning (1V) period also when the scanning signal Scan1 goes low to turn off the switching transistor 41. This voltage Vh1 is supplied to the gate of the driving transistor 44, for controlling the EL element 43 to emit light with brightness responsive to the voltage Vh1. In other words, the brightness of the display is controlled by the amplitude of the video signal Data1.

In the active matrix EL display according to the second embodiment having the aforementioned structure, a signal line driving circuit 1 and a scanning line driving circuit 2 are arranged on the same side of the display area 40 in a cascaded manner. Further, the scanning line driving circuit 2 is arranged outward beyond the signal line driving circuit 1.

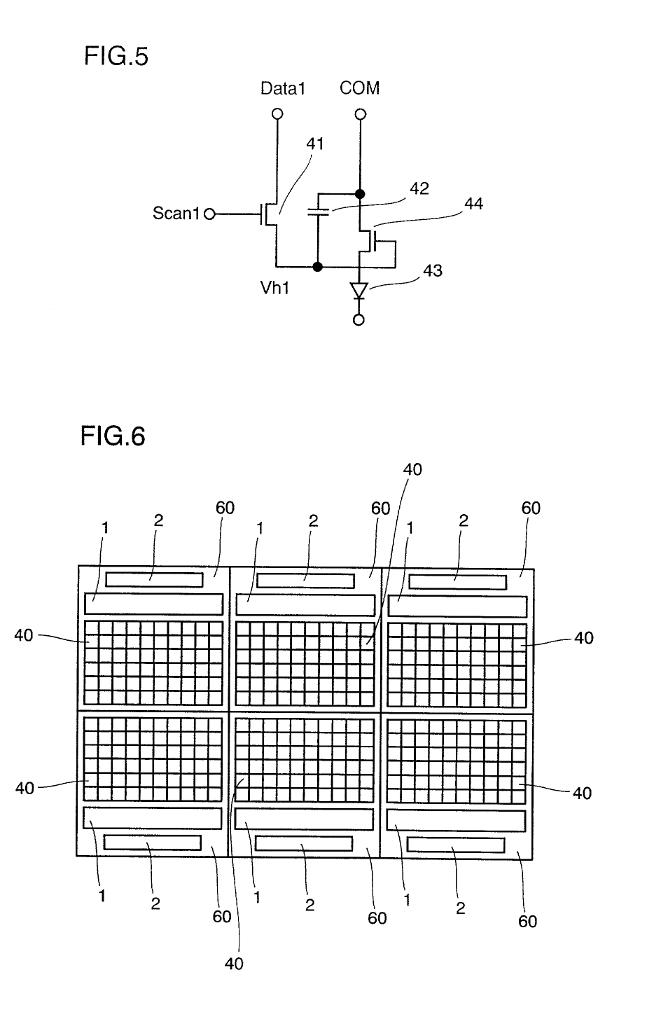

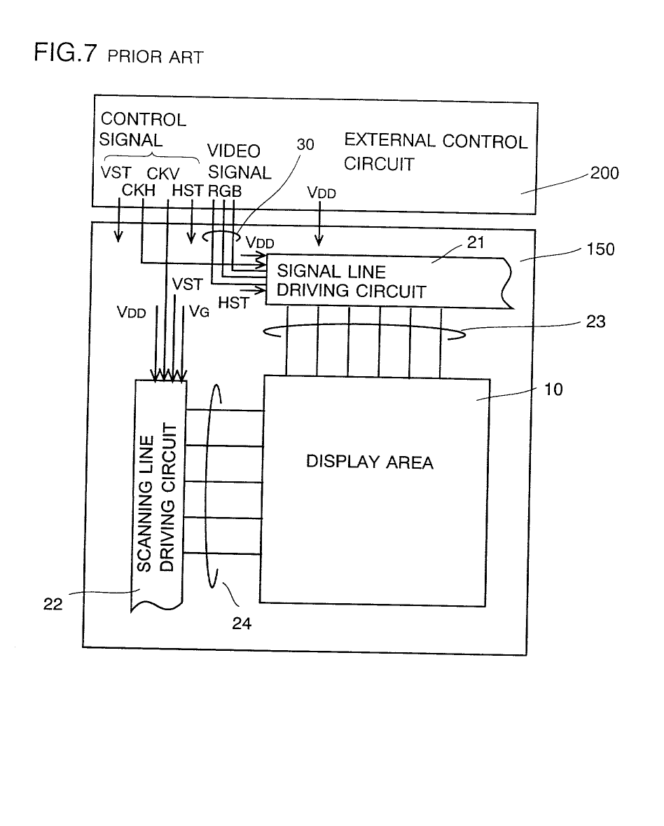

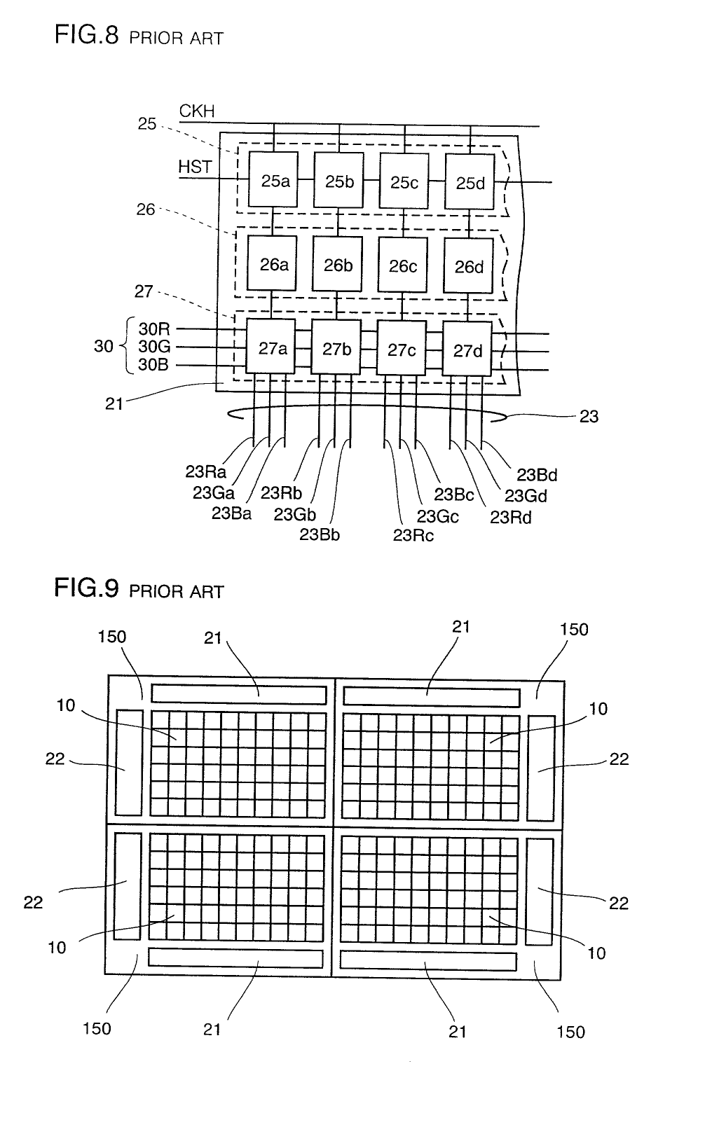

According to the second embodiment, the signal line driving circuit 1 and the scanning line driving circuit 2 are arranged on the same side of the display area 40 as hereinabove described so that no driving circuits are arranged on the remaining three sides other than that provided with the signal line driving circuit 1 and the scanning line driving circuit 2, whereby other EL panels 60 can be connected to these three sides respectively. Thus, an active matrix EL display consisting of a large-sized EL panel can be prepared by bonding miniature EL panels 60 to each other, as shown in FIG. 6. While six EL panels 60 are bonded to each other in FIG. 6, the number of the EL panels 60 bonded to each other in the row direction is so unlimited that the EL panels 60 can be bonded to each other to reach a desired size in the structure according to the second embodiment.

According to the second embodiment, the signal line driving circuit 1 and the scanning line driving circuit 2 are arranged on the same side in a cascaded manner similarly to the first embodiment, whereby the width for arranging the signal line driving circuit 1 and the scanning line driving circuit 2 can be reduced as compared with a case of transversely arranging the signal line driving circuit 1 and the scanning line driving circuit 2 on the same side. Thus, also in the miniature EL panel 60 having difficulty in arranging the signal line driving circuit 1 and the scanning line driving circuit 2 on the same side, the signal line driving circuit 1 and the scanning line driving circuit 2 can be collectively arranged on the same side.

According to the second embodiment, the scanning line driving circuit 2 is arranged outward beyond the signal line driving circuit 1 similarly to the first embodiment so that the signal line driving circuit 1 is arranged on the inner side closer to the display area 40, whereby the distance between the signal line driving circuit 1 and the display area 40 can be set equivalent to that in the prior art. Thus, it is possible to effectively prevent deterioration of image display resulting from delay of video signals or the like.

The internal structure of the signal line driving circuit 1 in the active matrix EL display according to the second embodiment is similar to that of the signal line driving circuit 1 in the active matrix LCD according to the first embodiment shown in FIG. 1. Therefore, an effect similar to that of the signal line driving circuit 1 described with reference to the first embodiment can be attained.

Although the present invention has been described and illustrated in detail, it is clearly understood that the same is by way of illustration and example only and is not to be taken by way of limitation, the spirit and scope of the present invention being limited only by the terms of the appended claims.

While the present invention is applied to an active matrix LCD (liquid crystal display) and an active matrix EL display in the aforementioned embodiments, for example, the present invention is not restricted to this but is also applicable to various active matrix display devices such as a plasma display and an FED.

What is claimed is:

1. A display device comprising:
a display area;
a plurality of scanning lines arranged in a first direction;
a plurality of signal lines arranged in a second direction;
a signal line driving circuit successively selecting a prescribed signal line from said plurality of signal lines and supplying a video signal; and
a scanning line driving circuit successively selecting a prescribed scanning line from said plurality of scanning lines and supplying a scanning signal, wherein
said signal line driving circuit and said scanning line driving circuit are arranged on the same peripheral side of said display area in a cascaded manner.

2. The display device according to claim 1, wherein
said scanning line driving circuit is arranged outward beyond said signal line driving circuit.

3. The display device according to claim 2, wherein
said signal line driving circuit includes a plurality of shift registers, a plurality of buffers and a plurality of analog switches, and
said shift registers, said buffers and said analog switches for adjacent said signal lines are arranged in a cascaded manner respectively.

4. The display device according to claim 3, further comprising a video signal line connected to said analog switches, wherein
said video signal line includes:
a first video signal line connected to said analog switches of odd stages, and
a second video signal line connected to said analog switches of even stages.

5. The display device according to claim 3, wherein
a wire from said scanning line driving circuit is input in said display area through said shift registers, said buffers and said analog switches arranged in a cascaded manner and shift registers, buffers and analog switches arranged adjacently thereto in a cascaded manner.

6. The display device according to claim 5, wherein
said wire from said scanning line driving circuit is connected to said scanning lines arranged in the row direction in said display area column-directionally through said shift registers, said buffers and said analog switches arranged in a cascaded manner and said shift registers, said buffers and said analog switches arranged adjacently thereto in a cascaded manner.

7. The display device according to claim 1, wherein
said display area, said signal line driving circuit and said scanning line driving circuit are formed on a display panel.

8. The display device according to claim 1, further comprising a plurality of display panels each including said display area, said scanning lines, said signal lines, said signal line driving circuit and said scanning line driving circuit, wherein
said signal line driving circuit and said scanning line driving circuit in each of said plurality of display panels are arranged on the same peripheral side of said display area in a cascaded manner, and
said plurality of display panels are connected with each other at least on a side of each said display panel other than the side provided with said signal line driving circuit and said scanning line driving circuit.

9. The display device according to claim 8, wherein
said plurality of display panels are connected with each other at least on two sides or three sides of each said display panel other than the side provided with said signal line driving circuit and said scanning line driving circuit.

10. The display device according to claim 8, wherein
said display panels are connected with each other in an even number of at least six.

11. The display device according to claim 1, wherein
said display area includes a plurality of pixels arranged in the form of a matrix.

12. The display device according to claim 1, including a liquid crystal display.

13. The display device according to claim 1, including an EL (electroluminescence) display.

14. The display device according to claim 13, wherein
a current supply line is arranged on said display area of said EL display.

15. The display device according to claim 13, wherein
said display area of said EL display includes a plurality of pixels arranged in the form of a matrix, and
each said pixel includes a switching transistor, a capacitor, an EL element and a driving transistor.
